(19) United States
(12) Patent Application Publication
(10) Pub. No.: US 2006/0020828 A1
(43) Pub. Date: Jan. 26, 2006

(54) Data restoring method, information processing apparatus, and computer-readable recording medium recording data restoring program

(75) Inventors: Kurato Aihara, Kawasaki (JP); Hidehiro Ono, Kawasaki (JP); Masakazu Watari, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/203,995

(22) Filed: Aug. 16, 2005

Related U.S. Application Data
(63) Continuation of application No. PCT/JP03/06746, filed on May 29, 2003.

(51) Int. Cl. G06F 12/14

(52) U.S. Cl. 713/193

(57) ABSTRACT

In a system designed to back up data of an information processing apparatus such as PDA, portable telephone or personal computer and further to restore data of a memory card into an information processing apparatus after authentication based on a UUID, a specified password is used so as to enable an rightful user to restore data even if a change of UUID takes place due to apparatus replacement or the like stemming from troubles while realizing the security protection of backed-up data of the information processing apparatus.

This nonprovisional application is a continuation application of and claims the benefit of International Application No. PCT/JP2003/006746, filed May 29, 2003. The disclosure of the prior application is hereby incorporated herein in its entirety by reference.

### FIELD OF THE INVENTION

The present invention relates to a data backup/restore technique of backing up data of portable information processing apparatus such as PDA (Personal Digital Assistant) and portable telephone or data of stationary information processing apparatus such as desktop computer and server into a recording medium (various types of memory cards) and of restoring the backed-up data into the information processing apparatus.

### DESCRIPTION OF THE RELATED ART

In recent years, as the portable information processing apparatus, PDAs have come into widespread use, and the PDAs currently manufactured by various companies and put on the market are designed to back up data including registry setting information, saved files and others in a SDRAM (Synchronous Dynamic Random Access Memory) of each of these PDAs into various types of memory cards [for example, MMC (Multi-Media Card), SD (Secure Disk) card, compact flash card, and others]. Naturally, the data backed up into a memory card can be restored (deciphered) into the main body of the PDA.

In addition, the PDA, which carries out the backup/restore processing, is made to have an enhanced security function in a manner such that a password is set in a memory card at the backup of data in the PDA and the password is required when the restore processing is conducted through the use of the memory card so that only the user who has conducted the backup can carry out the restoration in person. In this case, only when the password set in the memory card at the backup agrees with the password inputted at the restore (restoration), the data in the memory card can be restored into the PDA.

However, in the case of only a check using the password set at the backup, the identification of only the password enables the data in the memory card to be restored with respect to any device (PDA) so that the duplicate of the backed-up data becomes feasible. For this reason, undesirable situations occur in terms of copyright, such as the occurrence of duplicate (illegal copy) of pay application, or disagreeable situations develop in security, such as the theft of backed-up data.

Accordingly, there has been proposed a technique in which a device solid identification information (UUID: Universally Unique IDentifier) peculiar to the device is set in the memory card at the time of data backup and the device solid authentication is made through the use of this UUID at the restore, thereby permitting the restore of data in the memory card with respect to only the device which has carried out the backup (for example, Japanese Patent Laid-Open No. HEI 5-120149 (patent document 1), Japanese Patent Laid-Open No. HEI 8-278879 (patent document 2), Japanese Patent Laid-Open No. HEI 9-34799 (patent document 3), Japanese Patent Laid-Open No. HEI 9-265455 (patent document 4)).

However, in the case of the device solid authentication using the UUID, if the user renews the device (PDA) or performs repairs such as replacement of parts due to troubles or failures after the data backup, a change of the UUID of the device takes place so that the UUID at the backup becomes different from the UUID at the restore, which creates a problem in that even the rightful user to data in the memory card encounters difficulty in restoring the data into that device.

The present invention has been developed with a view to eliminating these problems, and it is an object of the invention to enable the rightful user to restore data even if a change of UUID takes place due to device replacement stemming from troubles or the like while realizing security protection (duplicate prevention) of backed-up data of information processing apparatus through a device solid authentication based on UUID.

### SUMMARY OF THE INVENTION

For this purpose, in accordance with an aspect of the present invention, there is provided a data restoring method of restoring data, backed up, into an information processing apparatus which is an object of restore, wherein a comparison is made between device identification information previously held in the restore object information processing apparatus and device identification information on an information processing apparatus which has held the backed-up data and, if these device identification information do not coincide with each other, the restore object information processing apparatus calculates/deciphers the device identification information of this information processing apparatus from a specified password, inputted, through the use of a predetermined deciphering algorithm to make a comparison between the deciphered device identification information and the device identification information previously held in the restore object information processing apparatus and, if these device identification information coincide with each other, carries out restore processing for restoring the backed-up data into the restore object information processing apparatus.

In addition, in accordance with another aspect of the present invention, there is provided a data backup/restore system, which restores data, backed up, into an information processing apparatus which is an object of restore, wherein the restore object information processing apparatus comprises deciphering algorithm holding means for previously holding a predetermined deciphering algorithm, device identification information holding means for previously holding device identification information for specifying this information processing apparatus, first device identification information comparing means for making, at data restore, a comparison between the device identification information held in the device identification information holding means and device identification information on an information processing apparatus which had held the backed-up data, deciphering means for, when a comparison decision in the first device identification information comparing means shows no coincidence between the device identification information, calculating/deciphering the device identification information on this information processing apparatus through the use of the predetermined deciphering algorithm held in the deciphering algorithm holding means, second device identification information comparing means for making a comparison between the device identification information obtained by the deciphering means and the device identification information held in the device identification information holding means, and restore executing means for, when a comparison decision in the second device identification information comparing means shows a coincidence between the device identification information, carrying out restore processing to restore the backed-up data into the restore object information processing apparatus.

Still additionally, in accordance with a further aspect of the present invention, there is provided an information processing apparatus, which includes an management unit for managing device identification information on the information processing apparatus and for enciphering the device identification information through the use of a predetermined enciphering algorithm to provide a specified password obtained through the encipherment and which is for use in a data restoring system made to restore data, backed up, into an information processing apparatus which is an object of restore, comprising deciphering algorithm holding means for previously holding a deciphering algorithm paired with the enciphering algorithm, device identification information holding means for previously holding device identification information for specifying this information processing apparatus, first device identification information comparing means for making, at data restore, a comparison between the device identification information held in the device identification information holding means and device identification information on an information processing apparatus which had held the backed-up data, deciphering means for, when a comparison decision in the first device identification information comparing means shows no coincidence between the device identification information, calculating/deciphering the device identification information on this information processing apparatus from the specified password, inputted, through the use of the deciphering algorithm held in the deciphering algorithm holding means, second device identification information comparing means for making a comparison between the device identification information obtained by the deciphering means and the device identification information held in the device identification information holding means, and restore executing means for, when a comparison decision in the second device identification information comparing means shows a coincidence between the device identification information, carrying out restore processing to restore the backed-up data.

Still additionally, in accordance with a further aspect of the present invention, there is provided a data restoring program which makes an information processing apparatus (computer) carry out the functions as the foregoing first device identification information comparing means, deciphering means, second device identification information comparing means and restore executing means, and in accordance with a further aspect of the present invention, there is provided a computer-readable recording medium which records the foregoing data restoring program.

The present invention can realize/provide a special support which enables a rightful user to carry out data restore (data duplicate) through the use of a specified password even if a change of UUID takes place due to device replacement stemming from troubles while realizing security protection (duplicate prevention) of backed-up data of an information processing apparatus through a check based on device identification information (UUID).

### BRIEF DESCRIPTION OF THE DRAWINGS

FIG. 1 is a block diagram showing a functional configuration of an information processing apparatus (PDA) according to an embodiment of the present invention;

FIG. 2 is a block diagram showing a hardware configuration of the information processing apparatus (PDA) as shown in FIG. 1;

FIG. 3 is a flow chart useful for explaining a data backup procedure in the information processing apparatus (PDA) as shown in FIG. 1;

FIG. 4 is a flow chart useful for explaining a data restoring procedure in the information processing apparatus (PDA) as shown in FIG. 1;

FIG. 5 is a flow chart showing one example of an enciphering algorithm to be used in this embodiment; and

FIG. 6 is a flow chart showing one example of a deciphering algorithm to be used in this embodiment

### DESCRIPTION OF THE PREFERRED EMBODIMENTS

An embodiment of the present invention will be described hereinbelow with reference to the drawings.

[1] Configuration of Information Processing Apparatus (PDA) and Data Backup/Restore System According to This Embodiment

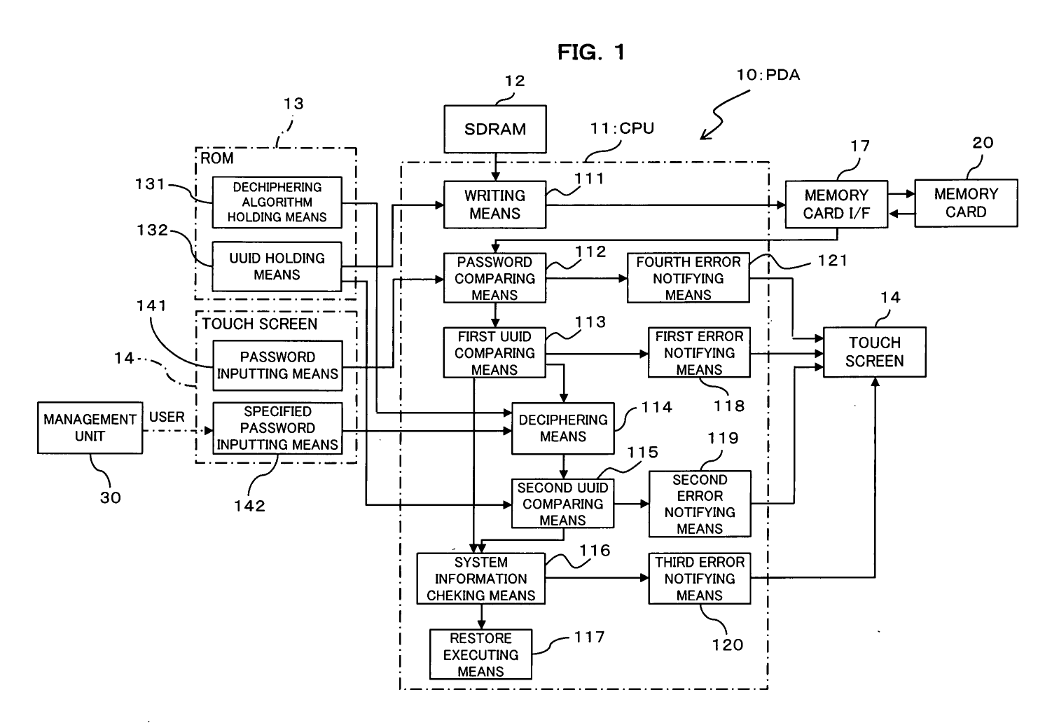

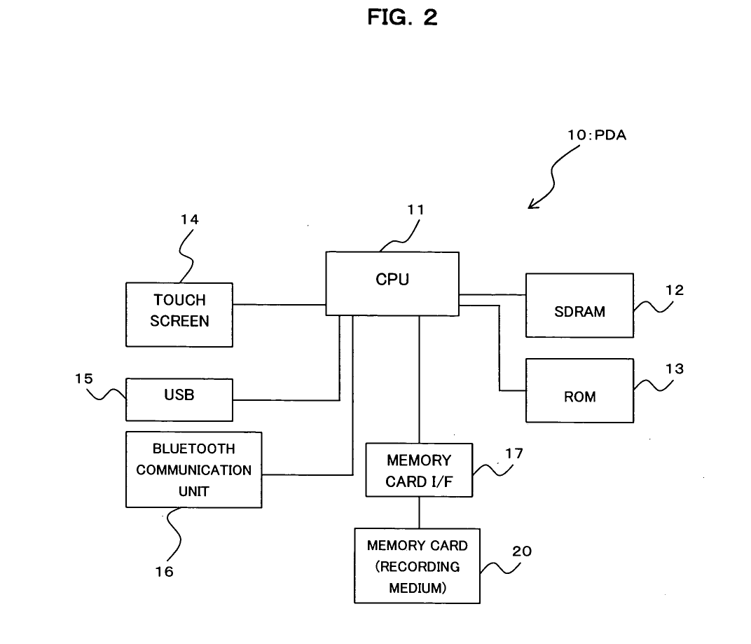

FIG. 1 is a block diagram showing a functional configuration of an information processing apparatus (PDA) according to an embodiment of the present invention, and FIG. 2 is a block diagram showing a hardware configuration of the information processing apparatus (PDA) as shown in FIG. 1.

The data backup/restore system according to this embodiment is designed to back up data of a PDA 10, serving as the information processing apparatus according to this embodiment shown in FIGS. 1 and 2, into a memory card (storage medium) 20 such as MMC, SD card or compact flash card and further to restore the data, backed up into the memory card 20, into the PDA 10.

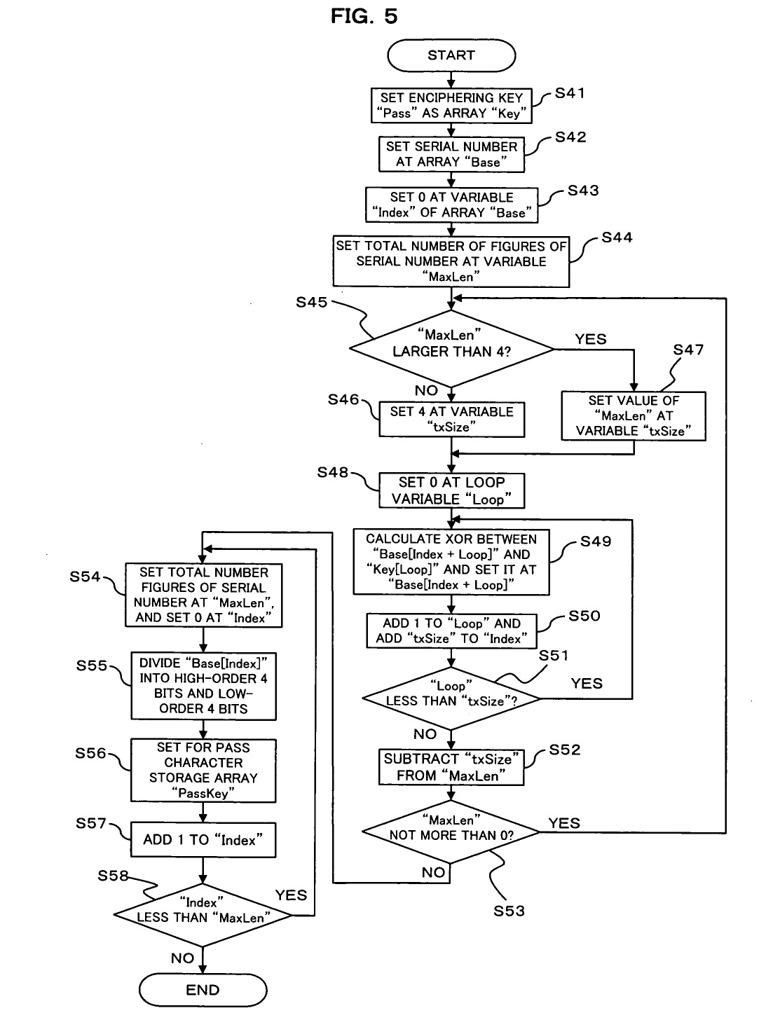

In addition, as shown in FIG. 1, the system according to this embodiment is equipped with a management unit 30. This management unit 30 is, for example, a management system used on a maker side manufacturing/dispensing the PDA 10, and is for managing UUID (device solid identification information unique to the PDA 10; device identification information) to be offered to a user and for providing a specified password, which is to be obtained by enciphering this UUID according to a predetermined enciphering algorithm (for example, see FIG. 5), to the user of the PDA 10. This specified pass word can be given from the management user 30 to a user when the user replaces the PDA 10 with new one due to troubles/failures or the like, or it can also be delivered from the management unit 30 to the user according to a request from the user when the user carries out the data restore with respect to the PDA 10 after the replacement.

First, referring to FIG. 2, a description will be given hereinbelow of a hardware configuration of the PDA 10 according to this embodiment. As shown in FIG. 2, the PDA 10 includes a CPU 11, a SDRAM 12, a ROM 13, a touch screen 14, a USB 14, a Bluetooth (registered trademark) communication unit 16 and a memory card interface 17.

The CPU (Central Processing Unit) 11 is for generalizing the control on the PDA 10 and is for realizing various functions by executing various types of application programs stored in the ROM 13. This CPU 11 realizes the functions as means 111 to 121 (see FIG. 1), mentioned later, by carrying out a given application program (data backup/restoring program), mentioned later.

The SDRAM (Synchronous Dynamic Random Access Memory) 12 is for holding various types of data including registry setting information and saved files and, in this embodiment, data held in this SDRAM 12 is backed up into the memory card 20 and the data backed up into the memory card 20 is restored into the SDRAM 12.

The ROM (Read Only Memory) 13 is, as mentioned above, for holding various types of application programs including a data backup/restoring program for realizing the functions inherent in the present invention and also fulfills the functions as preserving means 131 and 132 (see FIG. 1) to be mentioned later.

The touch screen 14 is made to fulfill the function to display various screens under control of the CPU 11 and the function to input data by pressing that screen with a finger, touch pen or the like. This data inputting function realizes the functions as inputting means 141 and 142 to be mentioned later.

The USB (Universal Serial Bus) 15 is a connector for connection of various types of USB handling peripheral devices and is connectable through a cable to other personal computers. Moreover, the PDA 10 can transmit/receive data with respect to a personal computer connected thereto through the cable. The Bluetooth (registered trademark) communication unit 16 is for making radio-communication of data with respect to external peripheral devices through the use of radio wave in 2.4-GHz band.

The memory card interface (I/F) 17 has an interface function between the foregoing memory card 20 and the aforesaid CPU 11 and, through this memory card interface 17, data is interchanged between the memory card 20 and the CPU 11.

Secondly, referring to FIG. 1, a description will be given hereinbelow of a functional configuration of the PDA 10 according to this embodiment.

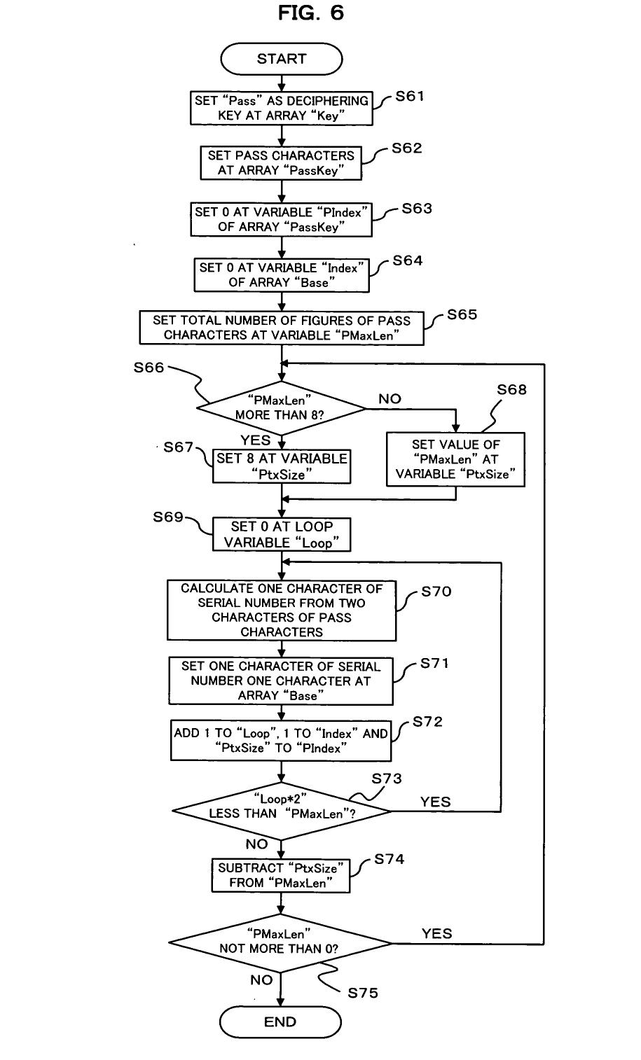

A deciphering algorithm holding means 131 provides a function which is to be realized by the aforesaid ROM 13 and is for previously holding a deciphering algorithm (deciphering program; for example, see FIG. 6) paired with the foregoing enciphering algorithm to be used on the management unit 30 side. This deciphering algorithm is for calculating/deciphering a UUID, which specifies this PDA 10, on the basis of the aforesaid specified password offered from the management unit 30.

A UUID holding means (device identification information holding means) 132 is a function to be realized by the aforesaid ROM 13 as in the case of the deciphering algorithm holding means 131, and is for previously holding the UUID which specifies this PDA 10. In this UUID holding means 132 (a given area of the ROM 13), the identification information peculiar to this PDA 10 is written/registered as a UUID at the shipment of the PDA 10.

A password inputting means (user identification information inputting means) 141 is a function to be realized by the aforesaid touch screen 14, and is used for a user to set/input a password (user authentication information for authentication of the user) to be written/registered in the memory card 20 at data backup and further to input a collation password (user identification information) at data restore.

A specified password inputting means 142 is a function to be realized by the aforesaid touch screen 14 as well as the password inputting means 141, and is used for a user to input the aforesaid specified password, acquired from the management unit 30, when a first UUID comparing means 113, mentioned later, makes a decision indicative of no coincidence between UUIDs.

Furthermore, each of means 111 to 121, which will be described hereinbelow, has a function to be realized when the CPU 11 executes a data backup/restoring program.

A writing means 111 is made to write data of the SDRAM 12 through the memory card interface 17 in the memory card 20 at data backup and further to write/set a password, inputted from the password inputting means 141 by a user, and a UUID, held in the UUID holding means 132, in the memory card 20. For example, these password and UUID are recorded as backup data or as a data file different from the backup data in the memory card 20.

A password comparing means (user identification information comparing means) 112 is designed to make, at data restore, a comparison/collation between the collation password inputted from the password inputting means 141 and the password written/set in the memory card 20.

A first UUID comparing means (first device identification information comparing means) 113 is designed to, when a decision in the password comparing means 112 indicates a coincidence between passwords, make a comparison/collation between a UUID held in the UUID holding means 132 and a UUID written/set in the memory card 20.

A deciphering means 114 is made to, when a decision in the first UUID comparing means 113 indicates no coincidence between the UUIDs, calculate/decipher an UUID of a PDA from a specified password, inputted through the specified password inputting means 142 by a user, through the use of the aforesaid deciphering algorithm held in the deciphering algorithm holding means 131.

A second UUID comparing means (second device identification information comparing means) 115 is made to make a comparison between the UUID obtained by the deciphering means 114 and the UUID held in the UUID holding means 132.

A system information checking means 116 is made to, when the first UUID comparing means 113 makes a coincidence decision or when the second UUID comparing means 115 makes a coincidence decision, check system information (version information on the operating system, version information on the ROM 13, or the like) about the PDA 10.

A restore executing means 117 is made to, when a decision in the system information checking means 116 shows that the restore is normally executable, conduct the restore processing to restore data backed up into the memory card 20 into the SDRAM 12 of the PDA 10. Concretely, through the use of this restore executing means 117, the data in the memory card 20 is read out through the memory interface 17 and written in the SDRAM 12.

A first error notifying means 118 is for, when the first UUID comparing means 113 makes a no-coincidence decision, notifying an error message to the effect of this decision to a user through a screen on the touch screen 14 and making a request to the user for the input of the aforesaid specified password.

A second error notifying means 119 is for, when the second UUID comparing means 115 makes a no-coincidence decision, notifying an error message indicative of this decision through a screen on the touch screen 14.

A third error notifying means 120 is for, when a decision in the system information checking means 116 indicates that the restore is unfeasible, notifying an error message indicative of this fact to the user through a screen on the touch screen 14.

A fourth error notifying means 121 is for, when a decision in the password comparing means 112 shows no coincidence, notifying an error message indicative of this decision to the user through a screen on the touch screen 14.

In this case, the functions as the above-mentioned writing means 111, password comparing means 112, first UUID comparing means 113, deciphering means 114, second UUID comparing means 115, system information checking means 116, restore executing means 117 and first to fourth notifying means 118 to 121 are realized in a manner such that the CPU 11 (computer, information processing apparatus) carries out a predetermined application program (data backup/restoring program).

In addition, in a case in which, in the PDA 10, a rewritable recording unit (for example, a flash memory, or the like) is employed in place of the ROM 13, the foregoing data backup/restoring program is offered in a state recorded in a computer-readable recording medium such as flexible disk, CD-ROM, CD-R, CD-RW or DVD. In this case, the computer (CPU 11) reads out the data backup/restoring program from this recording medium and transfers it to the aforesaid recording unit before using. Still additionally, it is also appropriate that the data backup/restoring program is recorded in, for example, a storage unit (recording medium) such as magnetic disk, optical disk or magneto optical disk and then offered from the storage unit through a communication line to the computer (CPU 11) to be stored in the aforesaid recording unit.

In this case, the computer represents a concept including a hardware and an OS (operating system) and signifies a hardware operating under control of the OS. Moreover, in a case in which the OS is unnecessary and an application program operates the hardware by itself, this hardware itself corresponds to the computer. The hardware is equipped with at least a microprocessor such as CPU and a means for reading out a computer program recorded in a recording medium. The application program serving as the aforesaid data backup/restoring program includes a program code for making the above-mentioned computer realize the functions as the writing means 111, the password comparing means 112, the first UUID comparing means 113, the deciphering means 114, the second UUID comparing means 115, the system information checking means 116, the restore executing means 117 and the first to fourth error notifying means 118 to 121. Moreover, a portion of the functions can also be realized by the OS instead of the application program.

Furthermore, among the recording mediums available in this embodiment, in addition to the above-mentioned flexible disk, CD-ROM, CD-R, CD-RW, DVD, magnetic disk, optical disk and magneto optical disk, there are various types of computer-readable mediums including IC card, ROM cartridge, magnetic tape, punch card, internal storage unit (memory such as RAM or ROM) of a computer, external storage unit and code-printed matter such as bar code.

[2] Operation (Data Backup Procedure and Data Restore Procedure) of This Embodiment

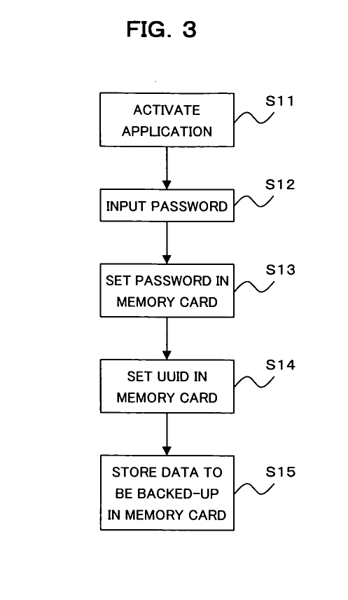

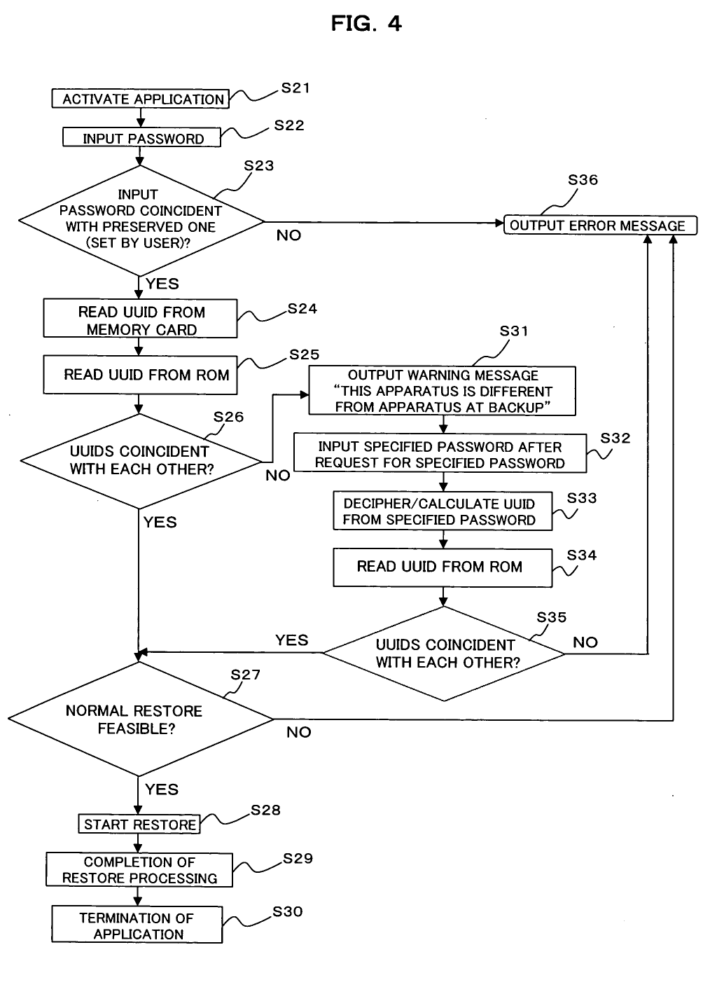

Secondly, with reference to a flow chart (steps S11 to S15) of FIG. 3 and a flow chart (steps S21 to S36) of FIG. 4, a description will be given hereinbelow of a data backup procedure and a data restore procedure in the PDA 10 thus configured.

When the data in the SDRAM 12 of the PDA 10 is backed up into the memory card 20, as shown in FIG. 3, a user first sets the memory card 20 in the memory interface 17 (memory card slot) and then activates an application program (data backup program) whereby the backup processing is conducted in the PDA 10, thereafter making a request for the execution of backup through the touch screen 14 (step S11). Following this, the user inputs a password for the user authentication through the password inputting means 141 (touch screen 14) according to an instruction screen displayed on the touch screen 14 (step S12).

In addition, the writing means 111 writes/sets, in the memory card 20, the password inputted from the password inputting means 141 through the memory card interface 17 and a UUID held in the UUID holding means 132 (steps S13 and S14), and writes data of the SDRAM 12 in the memory card 20 (step S15).

Meanwhile, when the data backed up into the memory card 20 as mentioned above is restored into the PDA 10, as shown in FIG. 4, the user sets the memory card 20 in the memory interface 17 (memory card slot) and then activates an application program (data restoring program) for carrying out restore processing in the PDA 10 and makes a request for the implementation of the restore through the touch screen 14 (step S21). Following this, the user inputs a collation password through the password inputting means 141 (touch screen 14) according to an instruction screen displayed on the touch screen 14 (step S22).

In response to the input of the collation password by the user, the password written/set in the memory card 20 is read out therefrom, and the password comparing means 112 makes a comparison/collation between the collation password inputted in the step S22 and the password in the memory card 20 (step S23).

In a case in which a decision in the password comparing means 112 shows that these passwords agree with each other (YES route from step S23), that is, when the personal authentication is made with respect to the user, a UUID written/set in the memory card 20 is read out therefrom (step S24) and an UUID of the PDA 10, which is an object of restore, is read out from the UUID holding means 132 of the PDA 10 (step S25), and the first UUID comparing means 113 makes a comparison/collation between these UUIDs (step S26).

In a case in which a decision in the first UUID comparing means 113 indicates a coincidence therebetween (YES route from step S26), that is, if the authentication is made that the PDA 10 at backup and the restore object PDA 10 are identical to each other, the system information checking means 116 checks the system information (version information on the operating system, version information on the ROM 13, or the like) on the PDA 10 (step S27).

If a result of the check in the system information checking means 116 shows that the restore is normally feasible (YES in step S27), the restore executing means 117 starts the restore processing (step S28) and reads out the data in the memory card 20 through the memory interface 17 and writes it in the SDRAM 12. When the restore processing reaches completion (step S29), the application comes to an end (step S30).

On the other hand, if the first UUID comparing means 113 makes a decision indicative of no-coincidence between the UUIDs (NO route from step S26), that is, when a decision is made that the PDA 10 at the backup is different from the restore object PDA 10, the first error notifying means 118 notifies, to the user, an error message (for example, outputting a warning message “this apparatus differs from the apparatus at the data backup”) to the effect of this decision through the touch screen 14 (step S31), with a request for input of a specified password being further made to the user (step S32).

Upon receipt of the request for input of the specified password, this user inputs, through the password inputting means 141 (touch screen 14), a specified password previously acquired from the management unit 30 or a specified password acquired through the inquiry at the management unit 30 after the receipt of the aforesaid request according to an instruction screen displayed on the touch screen 14 (step S32).

Incidentally, the user can acquire a specified password previously from the management unit 30 at the apparatus replacement of the PDA 10 and also can acquire the specified password by making an inquiry at the management unit 30 after the receipt of the aforesaid request as mentioned above. However, at this time, the management unit 30 confirms that the user is the identical person who has conducted the apparatus replacement, and then issues/offers the specified password to that user.

When the specified password is inputted by the user, the deciphering means 114 calculates/deciphers a UUID from the specified password, inputted in the step S32, according to the aforesaid deciphering algorithm held in the deciphering algorithm holding means 131 (step S33).

Thereafter, the UUID of the PDA 10, which is an object of restore, is read out from the UUID holding means 132 of this PDA 10 (step S34), and the comparison/collation between the UUID read out and the deciphered UUID obtained in the step S33 is made in the second UUID comparing means 115 (step S35).

In a case in which a decision in the second UUID comparing means 115 shows a coincidence between these UUIDs (YES route from step S35), the same processing as the above-described processing (steps S27 to S30) is conducted subsequently.

In the case of the coincidence decision in the second UUID comparing means 115, although the restore object PDA 10 differs from the PDA 10 at the data backup because of the apparatus replacement or the like stemming from troubles, the specified password only the user who has conducted the apparatus replacement can acquire from the management unit 30 as the identical person authenticates that the restore object PDA 10 is the rightful PDA 10 into which the backup data in the memory card 20 is to be restored, that is, that the user who carries out the restore is a rightful user.

Not until the management unit 30 employs a predetermined deciphering algorithm paired with the enciphering algorithm used for the production of the specified password, the specified password is deciphered into the UUID before the encipherment. Accordingly, the data in the memory card 20 is restored into the PDA 10 only when the rightful user, which has received the specified password from the management unit 30, inputs the specified password to the PDA 10 having the aforesaid predetermined deciphering algorithm.

On the other hand, in a case in which the second UUID comparing means 115 makes a no-coincidence decision on the UUIDs (NO route from step S35), the second error notifying means 119 notifies an error message indicative of this fact to the user through a screen on the touch screen 14 (step S36). Moreover, if the system information checking means 116 makes a decision that normal restore processing is unfeasible (NO route from step S27), the third error notifying means 120 notifies an error message to the effect of this decision to the user through a screen on the touch screen 14 (step S36). Still moreover, if the password comparing means 112 makes a no-coincidence decision (NO route from step S23), the fourth error notifying means 121 notifies an error message indicating this decision to the user through a screen on the touch screen 14 (step S36).

[3] One Example of Enciphering Algorithm

FIG. 5 is a flow chart (steps S41 to S58) showing one example of an enciphering algorithm to be used in this embodiment, and the following processing are conducted in the respective steps.

Step S41: A “Pass” is set as an enciphering key in an array “Key” (unit: one character).

Step S42: A serial number (UUID) is acquired and set in an array “Base” (unit: one character).

Step S43: 0 is set at an index variable “Index” of the array base.

Step S44: The total number of figures of the serial number is set at a variable “MaxLen”.

Step S45: A decision is made as to whether or not “MaxLen” exceeds 4.

Step 46: When “MaxLen” is not less than 4 (NO route from step S45), 5 set at a variable “txSize”.

Step S47: When “MaxLen” exceeds 4 (YES route from step S45), the value of “MaxLen” is set at the variable “txSize”.

Step S48: 0 is set at a loop variable “Loop”.

Step S49: The exclusive OR between the contents of “Base[Index+Loop]” and the contents of “Key[Loop]” is calculated and set at “Base[Index+Loop]”.

Step S50: 1 is added to “Loop” and “txSize is added to “Index”.

Step S51: A decision is made as to whether or not “Loop” is less than “txSize”. If “Loop” is less than “txSize” (YES route from step S51), the operational flow returns to the step S49.

Step S52: If “Loop” is not less than “txSize” (NO route from step S51), “txSize” is subtracted from “MaxLen”.

Step S53: A decision is made as to whether or not “MaxLen” is equal to or less than 0. If “MaxLen” is equal to or less than 0 (NO route from step S53), the operational flow returns to the step S45.

Step S54: When “MaxLen” exceeds 0 (YES route from step S53), the total number of figures of the serial number is set at “MaxLen” and 0 is set at “Index”.

Step S55: “Base[Index]” is divided into high-order 4 bits and low-order 4 bits. At this time, the high-order 4 bits are shifted by an amount corresponding to 4 bits in a right direction. Moreover, each of the high-order 4 bits is set to 0.

Step S56: The following setting is made in a pass character storage array “PassKey” (unit: one character).
PassKey[Index*2]=high-order 4 bits+0×40
PassKey[Index*2+1]=low-order 4 bits+0×40

Step S57: 1 is added to “Index”.

Step S58: A decision is made as to whether or not “Index” is less than “MaxLen”. If “Index” is less than “MaxLen” (YES route from step S58), the operational flow returns to the step S54. On the other hand, if “Index” is equal to or more than “MaxLen” (NO route from step S58), the enciphering processing comes to an end.

The pass character storage array “PassKey” obtained in this way is used as a specified password produced from a serial number (UUID).

[4] One Example of Deciphering Algorithm

Meanwhile, FIG. 6 is a flow chart (steps S61 to S75) showing one example of a deciphering algorithm to be used in this embodiment, and this deciphering algorithm is paired with the enciphering algorithm as shown in FIG. 5 and is made to decipher a specified password (pass characters), obtained according to this enciphering algorithm, into the original UUID (serial number). The following processing are conducted in the respective steps of the deciphering algorithm as shown in FIG. 6.

Step S61: A “Pass” is set as a deciphering key in an array “Key” (unit: one character).

Step S62: Pass characters (specified password) are acquired and set in an array “PassKey” (unit: one character).

Step S63: 0 is set at an index variable “PIndex” of the array “PassKey”.

Step S64: 0 is set at an index variable “Index” of a serial number array “Base”.

Step S65: The total number of figures of the pass characters is set at a variable “PMaxLen”.

Step S66: A decision is made as to whether or not “PMaxLen” exceeds 8.

Step S67: If “PMaxLen” exceeds 8 (YES route from step S66), 8 is set at a variable “PtxSize”.

Step S68: If “PMaxLen” is equal to or less than 8 (NO route from step S66), the value of “PMaxLen” is set at the variable “PtxSize”.

Step S69: 0 is set at a loop variable “Loop”.

Step S70: One character of the serial number is calculated from two characters of the pass characters as follows.
high-order 4 bits=PassKey[PIndex+Loop*2]−0×40
low-order 4 bits=PassKey[PIndex+Loop*2+1]−0×40

Step S71: One character of the serial number is calculated as follows from the calculated value.
Base[Index]=(shifting high-order 4 bits by an amount corresponding to 4 bits in a left direction)+low-order 4 bits

Step S72: 1 is added to “Loop”, 1 is added to “Index” and “PtxSize” is added to “PIndex”.

Step S73: A decision is made as to whether “Loop*2” is less than “PMaxLen”. If “Loop*2” is less than “PMaxLen” (YES route from step S73), the operational flow returns to the step S70.

Step S74: If “Loop*2” is equal to or more than “PMaxLen” (NO route from step S73), “PtxSize” is subtracted from “PMaxLen”.

Step S75: A decision is made as to whether or not “PMaxLen” is equal to or less than 0. If “PMaxLen” exceeds 0 (YES route from step S75), the operational flow returns to the step S66. On the other hand, If “PMaxLen” is equal to or less than 0 (NO route from step S75), the deciphering processing comes to an end.

The array “Base” obtained in this way becomes a serial number (UUID) obtained through the decipherment of the pass characters (specified password).

[5] Effects of This Embodiment

As described above, with the PDA 10 and the data backup/restore system according to an embodiment of the present invention, a double check is made through the use of a user authentication based on a password and a PDA 10 solid authentication based on a UUID, thereby realizing/providing a special support which enables a rightful user to carry out data restore (data duplicate) through the use of a specified password, offered from the management unit 30, even if a change of UUID accidentally takes place due to device replacement or the like stemming from troubles after data backup while more reliably realizing security protection (duplicate prevention) of backed-up data of the PDA 10.

According to this embodiment, for example, even if backed-up data (memory card 20), together with a password for user authentication, is stolen, when the specified password is not put to use, the backed-up data cannot be restored into devices other than the PDA 10 which has conducted the data backup. That is, since the restore processing can be conducted only when a personal authentication on the user is made through the use of a password and the UUID registered in the memory card 20 and the UUID of the restore object PDA 10 coincide with each other, it is possible to reliably prevent the backed-up data from being illegally restored (copied) into other devices.

Likewise, even if an application program or the like a user has purchased is once installed into the PDA 10 and is then backed up into the memory card 20 after data backup, it is possible to reliably prevent the application program in the memory card 20 from being illegally restored (copied) into other devices.

Meanwhile, in a case in which a change of the UUID occurs since a change of the PDA 10 takes place between the time of backup and the time of restore due to a good reason (for example, apparatus replacement due to troubles), in this embodiment, as described above, through the use of a specified password only the user who has conducted the apparatus replacement can acquire from the management unit 30, it is possible to authenticate that the restore object PDA 10 is a rightful PDA 10 into which the backed-up data in the memory card 20 is to be restored, that is, that the user who carries out the restore is a rightful user. Thus, when the authentication is made on the basis of the specified password, the backed-up data in the memory card 20 can be restored into the PDA 10.

In addition, in the PDA 10 according to this embodiment, in a case in which no-coincidence decision is made in each of the means 113, 115, 116 and 112, each of the error notifying means 118 to 121 notifies an error message indicative of this fact to the user through a screen on the touch screen 14, so the user can make a judgment on a factor of occurrence of no-coincidence, subsequent countermeasures and others.

[6] Others

It should be understood that the present invention is not limited to the above-described embodiment, and that it is intended to cover all changes and modifications of the embodiment of the invention herein which do not constitute departures from the spirit and scope of the invention.

For example, although in the above description of the embodiment the information processing apparatus is a PDA, the present invention is not limited to this, but it is also applicable to data backup/restore in various types of information processing apparatus such as portable telephone, notebook computer and desktop computer as in the case of the above-described embodiment, which can provide the same effects as those of the above-described embodiment.

In addition, although in the above-described embodiment the algorithms shown in FIGS. 5 and 6 are used as the enciphering algorithm and the deciphering algorithm, the present invention is not limited to this, but it is also possible to employ various other general types of enciphering algorithms and deciphering algorithms corresponding thereto, and the employment of any algorithm can provide the same effects as those of the above-described embodiment.

Still additionally, although in the above description of the embodiment a recording medium for the data backup is a memory card such as MMC, SD card or compact flash card, the present invention is not limited to this, but various types of recording mediums are also acceptable. Yet additionally, the recording medium for the data backup is not limited to portable types and, as well as the above-described embodiment, the present invention is also applicable in a case in which the data of the PDA 10 is backed up into another computer and this data is restored from the computer into the PDA 10.

Moreover, as a further embodiment, it is also appropriate that the data backup/restore program according to the present invention is offered in the form of operating on a computer to be connected to a PDA in a wire or radio fashion so that the backup/restore of data of the PDA is conducted through the use of the data backup/restore program according to the present invention.

### INDUSTRIAL APPLICABILITY

As described above, according to the present invention, the employment of a specified password given from a management unit enables the rightful user to restore data regardless of a change of UUID due to apparatus replacement stemming from troubles while realizing the security protection of backed-up data of an information processing apparatus.

Therefore, the present invention is suitable for use in a system of backing up data of portable information processing apparatus such as PDA and portable telephone or data of stationary information processing apparatus such as desktop computer and server, and this can provide extremely high availability.

What is claimed is:

1. A data restoring method of restoring data, backed up, into an information processing apparatus which is an object of restore, comprising the steps of:
making a comparison between device identification information previously held in said restore object information processing apparatus and device identification information on an information processing apparatus which had held the backed-up data;
if said device identification information do not coincide with each other, in said restore object information processing apparatus, calculating/deciphering said device identification information of said information processing apparatus from a specified password, inputted, through the use of a predetermined deciphering algorithm;
making a comparison between the deciphered device identification information and said device identification information previously held in said restore object information processing apparatus; and
if said device identification information coincide with each other, carrying out restore processing for restoring the backed-up data into said restore object information processing apparatus.

2. The data restoring method according to claim 1, wherein the backed-up data includes user identification information inputted at the data backup and, in said restore object information processing apparatus, a comparison is made between user identification information inputted by a user and said user identification information inputted at the backup and, if said user identification information coincide with each other, a comparison is made between said device identification information.

3. The data restoring method according to claim 1, wherein, if said device identification information previously held in said restore object information processing apparatus and device identification information for specifying an information processing apparatus which has carried out the data backup does not coincide with each other, an error message indicative of the no-coincidence is notified and a request for inputting of said specified password is issued.

4. The data restoring method according to claim 1, wherein, if the deciphered device identification information and said device identification information previously held in said restore object information processing apparatus do not coincide with each other, an error message indicative of the no-coincidence is notified.

5. The data restoring method according to claim 1, wherein, if the deciphered device identification information and said device identification information previously held in said restore object information processing apparatus coincide with each other, a check is made with respect to system information on said information processing apparatus prior to said restore processing, and said restore processing is conducted when a result of the check shows that the restore is feasible.

6. The data restoring method according to claim 5, wherein, if a result of the check shows that the restore is unfeasible, an error message indicative of the check result is notified.

7. The data restoring method according to claim 1, wherein said specified password is obtained in a manner such that a management unit, which manages device identification information on information processing apparatus, enciphers said device identification information on said restore object information processing apparatus according to a predetermined enciphering algorithm paired with said deciphering algorithm.

8. The data restoring method according to claim 1, wherein the backed-up data includes device identification information for specifying information processing apparatus which has carried out the data backup.

9. An information processing apparatus, which includes an management unit for managing device identification information on information processing apparatus and for enciphering said device identification information through the use of a predetermined enciphering algorithm to provide a specified password obtained through the encipherment and which is for use in a data restoring system made to restore data, backed up, into an information processing apparatus which is an object of restore, comprising:
deciphering algorithm holding means for previously holding a deciphering algorithm paired with said enciphering algorithm;
device identification information holding means for previously holding device identification information for specifying said information processing apparatus;
first device identification information comparing means for making, at data restore, a comparison between said device identification information held in said device identification information holding means and device identification information on an information processing apparatus which had held the backed-up data;
deciphering means for, when a comparison decision in said first device identification information comparing means shows no coincidence between said device identification information, calculating/deciphering said device identification information on said information processing apparatus from said specified password, inputted, through the use of said deciphering algorithm held in said deciphering algorithm holding means;
second device identification information comparing means for making a comparison between said device identification information obtained by said deciphering means and said device identification information held in said device identification information holding means; and
restore executing means for, when a comparison decision in said second device identification information comparing means shows a coincidence between said device identification information, carrying out restore processing to restore the backed-up data.

10. The information processing apparatus according to claim 9, further comprising user identification information comparing means for making a comparison between user identification information inputted by a user and user identification information inputted at the backup and included in the backed-up data so that, if a decision in said user identification information comparing means shows a coincidence between said user identification information, said first device identification information comparing means makes the comparison between said device identification information.

11. The information processing apparatus according to claim 9, further comprising first error notifying means for, if a decision in said first device identification information comparing means shows no coincidence therebetween, notifying an error message indicative of the no-coincidence decision and for making a request for inputting of said specified password.

12. The information processing apparatus according to claim 9, further comprising second error notifying means for, if a decision in said second device identification information comparing means shows no coincidence therebetween, notifying an error message indicative of the no-coincidence decision.

13. The information processing apparatus according to claim 9, further comprising system information checking means for, if a decision in said second device identification information comparing means shows a coincidence therebetween, checking system information on said information processing apparatus prior to said restore processing by said restore executing means so that said restore executing means carries out said restore processing when a decision in said system information checking means shows that the restore is feasible.

14. The information processing apparatus according to claim 13, further comprising third error notifying means for, if a decision in said system information checking means shows that the restore is unfeasible, notifying an error message indicative of the fact that the restore is unfeasible.

15. The information processing apparatus according to claim 9, wherein the backed-up data includes device identification information for specifying an information processing apparatus which has carried out the data backup.

16. A computer-readable recording medium recording a program which makes an information processing apparatus, used in a data restoring system made to restore data, backed up, into an information processing apparatus which is an object of restore, carry out data restore, said program making said information processing apparatus carry out functions as:
first device identification information comparing means for making, at the data restore, a comparison between device identification information previously held in said information processing apparatus and device identification information on an information processing apparatus which had held the backed-up data;
deciphering means for, when a comparison decision in said first device identification information comparing means shows no coincidence between said device identification information, calculating/deciphering said device identification information on said information processing apparatus from a specified password, inputted, through the use of a predetermined deciphering algorithm;
second device identification information comparing means for making a comparison between said device identification information obtained by said deciphering means and said device identification information previously held in said information processing apparatus; and
restore executing means for, when a comparison decision in said second device identification information comparing means shows a coincidence between said device identification information, carrying out restore processing to restore the backed-up data.

17. The computer-readable recording medium recording the data restoring program according to claim 16, wherein said program makes said information processing apparatus carry out a function as user identification information comparing means for making a comparison between user identification information inputted by a user and user identification information inputted at the backup and included in the backed-up data so that, if a decision in said user identification information comparing means shows a coincidence between said user identification information, said first device identification information comparing means makes the comparison between said device identification information.

18. The computer-readable recording medium recording the data restoring program according to claim 16, wherein said program makes said information processing apparatus further carry out a function as first error notifying means for, when a decision in said first device identification information comparing means shows no coincidence therebetween, notifying an error message indicative of the no-coincidence decision and making a request for inputting of said specified password.

19. The computer-readable recording medium recording the data restoring program according to claim 16, wherein said program makes said information processing apparatus further carry out a function as second error notifying means for, when a decision in said second device identification information comparing means shows no coincidence therebetween, notifying an error message indicative of the no-coincidence decision.

20. The computer-readable recording medium recording the data restoring program according to claim 16, wherein said program makes said information processing apparatus further carry out a function as system information checking means for, if a decision in said second device identification information comparing means shows a coincidence therebetween, checking system information on said information processing apparatus prior to said restore processing by said restore executing means so that said restore executing means carries out said restore processing when a decision in said system information checking means shows that the restore is feasible.

21. The computer-readable recording medium recording the data restoring program according to claim 20, wherein
said program makes said information processing apparatus further carry out a function as third error notifying means for, if a decision in said system information checking means
shows that the restore is unfeasible, notifying an error message indicative of the fact that the restore is unfeasible.

22. The computer-readable recording medium recording the data restoring program according to claim 16, wherein
said specified password is obtained in a manner such that a management unit, which manages device identification information on information processing apparatus, enciphers said device identification information on said restore object information processing apparatus according to a predetermined enciphering algorithm paired with said deciphering algorithm.

23. The computer-readable recording medium recording the data restoring program according to claim 16, wherein the backed-up data includes device identification information for specifying an information processing apparatus which has carried out the data backup.
